(19) United States
(12) Patent Application Publication
(10) Pub. No.: US 2009/0024933 A1
(43) Pub. Date: Jan. 22, 2009

(54) SYSTEM AND METHOD FOR DISTRIBUTION AND INTERACTION BETWEEN NETWORKED USERS

(76) Inventors: John Charles Smedley, Poway, CA (US); Gregory Short, Lake Arrowhead, CA (US); William Harry Trost, Oceanside, CA (US); Nathan Pearce, San Diego, CA (US); Rob Hill, San Diego, CA (US)

Correspondence Address: MAYER & WILLIAMS PC, 251 NORTH AVE. WEST, 2ND FLOOR, WESTFIELD, NJ, 07090, US

(21) Appl. No.: 12/125,810

(22) Filed: May 22, 2008

Related U.S. Application Data
(60) Provisional application No. 60/931,595, filed on May 23, 2007.

(51) Int. Cl. G06F 3/00

(52) U.S. Cl. 715/753; 463/42

(57) ABSTRACT

Systems and methods are provided for conducting games or other interactions between networked computers, mobile devices, or other such client devices. Players compete via graphical elements, termed “devices”, that move and engage each other on top of existing windows, such as on a player's PC desktop or mobile device background. The devices may be tanks, spaceships, characters, or any other graphical element that can take part in a game or interaction. The system and method provides for short-term, casual, online games using light clients or instant messaging protocols. The games may be played quickly and easily, with minimal interruption of other endeavors. Players may conveniently choose opponents via a friends list, lobby system, or other such method, in an easy-to-use, e.g., drag-and-drop interface.

### CROSS-REFERENCE TO RELATED APPLICATIONS

This application claims the benefit of U.S. Provisional Patent Application Ser. No. 60/931,595, filed May 23, 2007, entitled “Distribution and Interaction Among Networked Clients”, owned by the assignee of the present invention and herein incorporated by reference in its entirety.

### BACKGROUND

Users of networked computer systems enjoy interacting with one another while online. For example, players of massive multiplayer online games (MMOGs) enjoy not only the game but also the social interaction with other like-minded users.

Certain online multiplayer games require an investment of time and effort to master. In some cases, players may lack the time required to learn and play such games effectively. This may be especially true in situations where a player desires a game as a diversion during a work break or the like. In these cases, a player generally wishes to play desire a casual game, e.g., one that can be played in only a few minutes.

### SUMMARY

Systems and methods are provided for conducting games or other interactions between networked computers, mobile devices, or other such client devices. Players compete via graphical elements, termed “devices”, that move and engage each other on top of existing windows, such as on a player's PC desktop or mobile device background. In certain implementations, a separate window for the interaction may also be provided. The devices may be tanks, spaceships, characters, or any other graphical element that can take part in a game or interaction.

Generally, to initiate a game, a player finds an opponent and selects a device with which to compete. Regarding the device, particular devices may have certain rules of movement applicable to the same. For example, a truck may have different rules than a tank, ship, or airplane. Alternatively, a group of devices (or even all devices) may be provided with the same rules. These rules pertain to, e.g., speed of movement, what weapons are equipped, maneuverability, and the like.

Several methods may be employed to find an opponent. In one implementation, a player may choose one or more opponents from a list previously created for purposes of the system, or may invite another player to a game via an email, instant message, private message (e.g., within a social networking site), or the like. In other implementations, e.g., where a player logs on to a website to play, the player may be matched with other players through the website, e.g., via a ladder, a pick-up list, a lobby-based system, or via any other matching system.

Communications between devices may be by way of any appropriate communications protocol, including instant messaging systems, a light client, or other sorts of networking techniques. The interface may be an easy-to-use drag-and-drop type interface. For example, a player may initiate a game by simply dragging-and-dropping a device onto another player's name in a buddy list.

Implementations may include one or more of the following. Besides games, other content may be shared and employed in a collaborative way, including educational tools or online meeting tools. Games may often be casual, short-term, mini-games, although more complex games may also be played within the context of the system and method. A player may operate multiple devices in a given game, e.g., a player may operate a fleet of ships, and the separate devices may be individually controllable. Players may control their devices via an interface on a computer system, mobile phone, PDA, game console, or any other network client, many of which are also listed below. Besides causing “damage” to each other's devices, players may cause “damage” to other features on the desktop, such as windows, icons, and menus, and this “damage” may be indicated by the presence of shattered-glass lines, craters, etc.

In one aspect, the invention is directed towards a method of interacting over a computer network, comprising steps of activating an interaction client on a first computer system; displaying one or more devices by a user interface associated with the interaction client, wherein the interaction client stores device data for each device; receiving a selection of one or more devices displayed by the user interface; displaying a list of one or more names by the user interface, the names corresponding to respective users and computer systems; receiving a selection of one or more of the displayed names; transmitting the device data for the selected device to the computer system or systems corresponding to the selected name or names; and transmitting and receiving interaction data to and from the computer system or systems corresponding to the selected name or names, wherein the interaction data indicate commands input by users for their devices.

Implementations of the invention may include one or more of the following. The interaction client may be a game, and the devices may be objects within the game. The computer systems may be selected from the group consisting of: mobile devices, personal computers, personal digital assistants, smart phones, mobile phones, cell phones, satellite phones, tablet computers, handheld computers, desktop computers, and laptop computers. The method may further comprise displaying the device corresponding to the device data on the first computer system and displaying one or more respective devices on the computer system or systems corresponding to the selected name or names. The devices may be displayed on a personal computer desktop or background. The user interface may employ drag-and-drop functionality. The transmitting and receiving may be performed by a light client or by an instant messaging system. The method may further comprise modifying the appearance of a graphical element on the computer desktop or background in response to the transmitting and receiving interaction data. The interaction client may be an educational or meeting tool. The devices may be modified by the players, and the method may further comprise receiving a request from the interaction client to modify their associated device. The method may further comprise receiving compensation from a player through the interaction client as consideration for the requested modification.

In another aspect, the invention is directed towards a method of operating an online video game in which a game client application has been downloaded to a first computer system and to a second computer system, the client applications enabling a game to be played between the first and second computer systems. Steps of the method include providing a user interface including a first device corresponding to the first computer system and a second device corresponding to the second computer system; receiving input commands from the first and second computer systems, input commands from the first computer system corresponding to commands to move or operate the first device, and input commands from the second computer system corresponding to commands to move or operate the second device; transmitting data, corresponding to the received input commands of one computer system, to the other computer system; and receiving the transmitted data and updating the movement or operation of each device on each computer system according to the received input commands and received data. The transmitting is performed using an instant messaging system, a light client, or a lobby system in a web application, the web application in communication with each of the first and second computer systems.

Implementations of the invention may include one or more of the following. The receiving input commands corresponds to receiving commands to move the device in one of at least four possible directions, and wherein the receiving input commands further corresponds to receiving commands to fire a projectile. The first or second devices are displayed on a personal computer desktop or mobile phone background. The method may further comprise modifying the appearance of a graphical element on the computer desktop or background in response to the received data.

In another aspect, the invention is directed towards a system for use by a first user to interact over a computer network with one or more other users, including a device database module to store information corresponding to one or more devices, the devices being graphical elements; a friends database module to store information corresponding to one or more users associated with a first user; a user interface module through which the first user may choose at least one device and at least one user with which and with whom to interact, respectively; and a transmission module to send and receive interaction data.

Implementations of the invention may include one or more of the following. The interaction data may include information about movement and actions of the devices. The devices may correspond to elements in a game and the interaction data may correspond to movements or actions of the devices within the game. The device database module, friends database module, user interface module, and transmission module, may be located on a computer system, and the computer system may be selected from the group consisting of: mobile devices, personal computers, personal digital assistants, smart phones, mobile phones, cell phones, satellite phones, tablet computers, handheld computers, desktop computers, and laptop computers. The transmission module may send and receive data using an instant messaging system; a light client; or a lobby system in a web application, the web application in communication with each of the first and second computer systems.

Advantages of the invention may include one or more of the following. The system and method provides for short-term, casual, online games using light clients or instant messaging protocols. The games may be played quickly and easily, with minimal interruption of other endeavors. Players may conveniently choose opponents via a friends list, lobby system, or other such method, in an easy-to-use, e.g., drag-and-drop interface.

Other advantages will be apparent from the description that follows, including the figures and claims.

### BRIEF DESCRIPTION OF THE DRAWINGS

FIG. 1 illustrates exemplary simplified screenshots, on two screens, displaying views seen by a user and their opponent during play of the system and method for interaction between users.

FIG. 2 illustrates exemplary simplified screenshots, on two screens, displaying views seen by a user during setup of a game embodying a system and method for interaction between users.

FIG. 3 is a flowchart illustrating a method for interaction between users.

FIG. 4 is a schematic layout showing a network which may be employed for interaction between users.

FIG. 5 is a flowchart illustrating another method for interaction between users.

FIG. 6 is a flowchart illustrating yet another method for interaction between users.

FIG. 7 is a schematic layout showing a system which may be employed for interaction between users.

FIG. 8 is a schematic layout showing another system which may be employed for interaction between users.

FIG. 9 illustrates a portion of a user interface displaying command controls for operating the system and method for interaction.

FIG. 10 illustrates a schematic depiction of one portion of a system for interaction.

FIG. 11 illustrates a system for interaction employing online meeting clients.

FIG. 12 illustrates a system for interaction for use in education applications.

### DETAILED DESCRIPTION

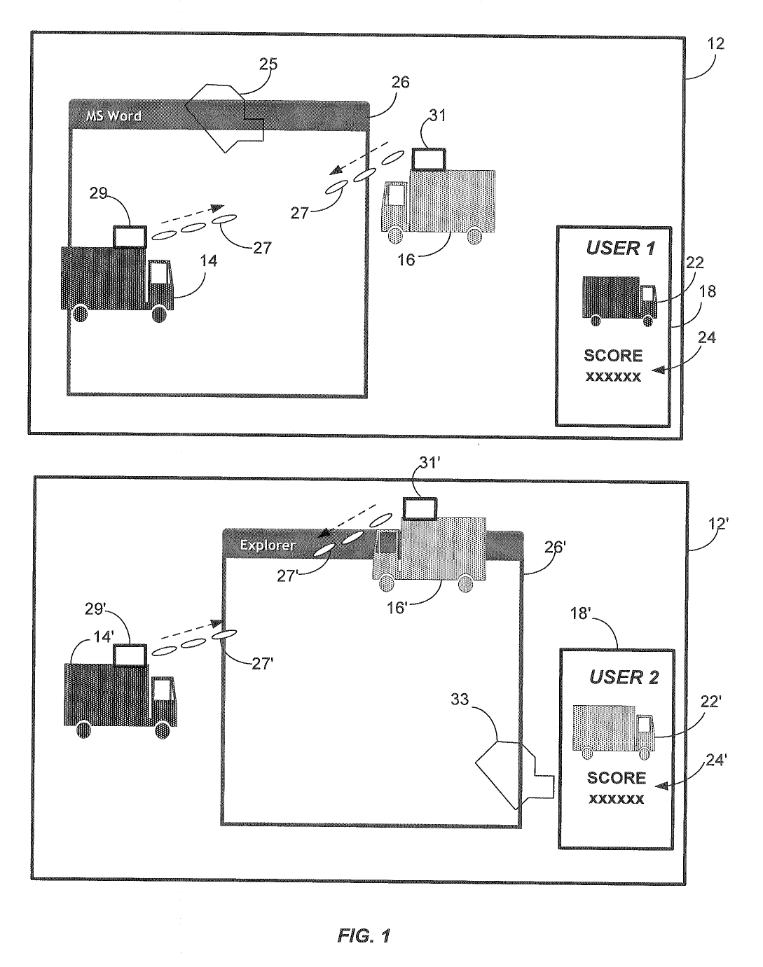

Referring to FIG. 1, two computer screens 12 and 12′ are illustrated displaying one exemplary implementation of the system and method for interaction. The top screen 12 shows a display screen as seen by user 1 and the bottom screen 12′ shows a display screen as seen by user 2. Each screen is generally a computer monitor, though any display screen may be employed, e.g., those corresponding to tablet PCs, cell phones, personal digital assistants, and the like.

In a desktop computer environment, the program can execute to display the devices on the “desktop” of the operating system. For example, in a tank game system, the devices are tanks and the program displays the players' tanks above other items, e.g., windows and icons, as the tanks move and shoot according to user commands.

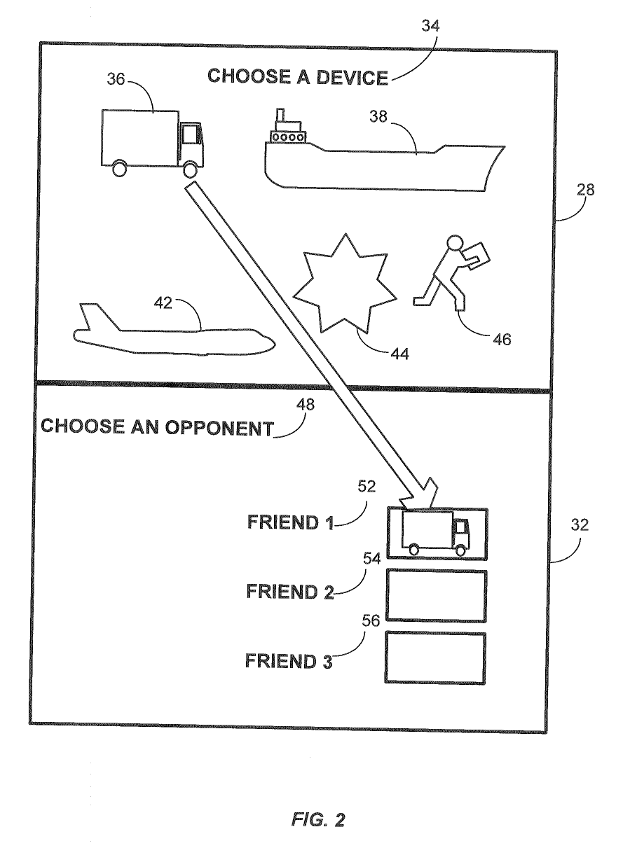

With reference to the figure, user 1 and user 2 operate game units that are represented on the screen by devices 14 and 14′, respectively. In FIG. 1, the devices are weaponized trucks. In general, the devices may vary widely, and may be as simple as geometric shapes or as complex as humanoid avatars, or even more complex. Examples of devices include ships, planes, weaponized vehicles, tanks, animated objects, pirate ships, and the like. Certain variations, though not an exhaustive or exclusive list, are also provided below in connection with FIG. 2.

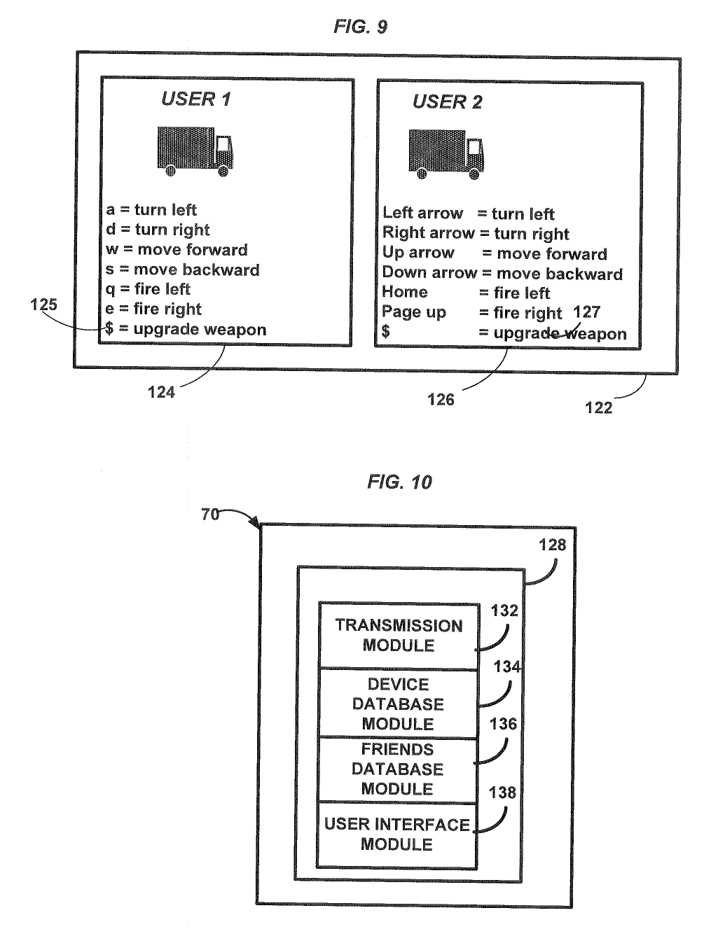

The devices may be moved on the screen under control of the users. User 1 controls device 14, and user 2 controls device 14′. Additional details of movement controls and an associated interface are described below in connection with FIG. 9. In general, the users see the results of their actions by watching screens 12 and 12′. Users may also be enabled to control more than one device.

While interactive and multiplayer games may take on many forms, one useful type is a shooting game, where devices 14 and 14′ shoot at each other until one device reaches an unacceptable level of damage. Such a game is shown in FIG. 1 where device 14 has a weapon 29 that shoots projectiles 27, and device 16 is similarly equipped with a weapon 31, here shown as shooting the same kind of projectiles 27. Of course, numerous variations will be seen. For example, the devices may be equipped with different weapons. The effect of damage to the devices may been shown on the screen as craters, holes, wreckage, and other visual effects, displayed as affecting the devices themselves. User 1 will see the effects as displayed on the components of their device and screen; user 2 will see the effects on their screen, as displayed on the primed counterparts of these components.

Certain damage effects, however, will vary from screen to screen. As noted, in one implementation, craters and scorch marks may appear to “damage” players' desktops while the war or battle is happening, e.g., causing displayed windows, icons, menus, and the like, to appear to suffer damage. For example, damage effect 25 on the user 1 screen appears to damage a window 26, while damage effect 33 on the user 2 screen appears to damage a window 26′. Besides damage to the player devices, other displayed damage is generally different on each screen, as each user generally has different windows open, icons displayed, and so on.

One or more information boxes 18 and 18′ may be displayed to inform users of their score 24 and 24′, respectively, as well as to display other information if desired. For example, a depiction or icon of their associated device, shown as icons 22 and 22′, respectively, may be seen and the same may optionally indicate a level of damage by, e.g., colored indications on the device icon.

FIG. 2 illustrates an exemplary user interface by which a user may invite another user to play a game. Two screens are shown: a device selection screen 28 and an opponent (or “other” user) selection screen 32. These screens may be displayed sequentially, in any order, or adjacent to each other as shown.

Through this user interface, a user opens a connection to another user's computer system. In one implementation, each can then see the other's device(s) through the respective system's display. In an alternative implementation, only the initiating user can see devices (until the game or other engagement is commenced). For example, the initiating user can see all the devices for which device data is available.

Device data may be stored on each user's computer system, e.g., within a light client, or may be downloaded from a central repository at the time of use. Data for a given device may also be stored on the initiator's computer system, and then transferred to the opponent's computer system prior to commencement of the game. In any case, once appropriate device data has been retrieved, the users can interact or play a game using the devices, each controlling a device on the user's own computer system in real time.

In more detail, and referring back to FIG. 2, in the device selection screen 28, a suitable request 34 is displayed, along with a choice of devices 36-46. As noted above, the devices may vary greatly. For exemplary purposes only, certain devices have been showed in the screen 28 of FIG. 2, including a truck 36, a ship 38, a plane 42, a geometric shape (a star) 44, and a human FIG. 46.

In the opponent or other user selection screen 32, a suitable request 48 is displayed, along with a choice of users. Users may be part of a “friends” or other group that has been set up by the user for purposes of this system, or may be a group that has been defined for other purposes, such as other sites, e.g., social networking sites. A group may also be constructed from address files on the user's system. A group may further be suggested by the system, according to, e.g., information about which users are currently logged on to a games site, or which users are logged on to a site designed to assist the implementation of the system (in the case where one has been so constructed). In FIG. 2, for exemplary purposes only, a first friend 52, a second friend 54, and a third friend 56 have been displayed. The initiating user may select one or more of these friends with which to play a game. One way of inviting a friend to play, particularly where screens 28 and 32 are displayed simultaneously, is to drag-and-drop a device onto the friend's name, onto a box associated with a friend (as shown in the figure), or by some other technique to associate a device with another user. Assuming the chosen user is connected to the initiating user, either through the internet or using the same light client, such a drag-and-drop action may cause a pop-up box to appear on the chosen user's desktop, asking if they wish to play the chosen game. Alternatively, the action may cause one or more devices to appear on the desktop of the chosen user (or onto a background, if the chosen user is operating a cell phone). Following this step, the users can engage in interaction, such as a game or other engagement. Each controls their own device or devices in real time on their own desktop, with the interaction being viewed on and taking place on both desktops simultaneously.

Referring back to FIG. 2, the screens 28 and 32 may be displayed by activating a client program, which may be a sub-program or sub-routine of a larger program. For example, a user may start a game by opening an appropriate panel in an application program, such as Sony Online Entertainment®'s Station® Launcher application and performing the drag-and-drop operation such as is described above. This action initiates an interactive session that plays out on both users' desktops. Each user sees both devices and can pilot their own to compete with the other. A competition, e.g., a battle or war, may last, e.g., 5 seconds, 1 minute, 5 minutes, or more, and any time period between these. A battle, war, or other game may last longer if more devices, e.g., weapons or vehicles, are deployed.

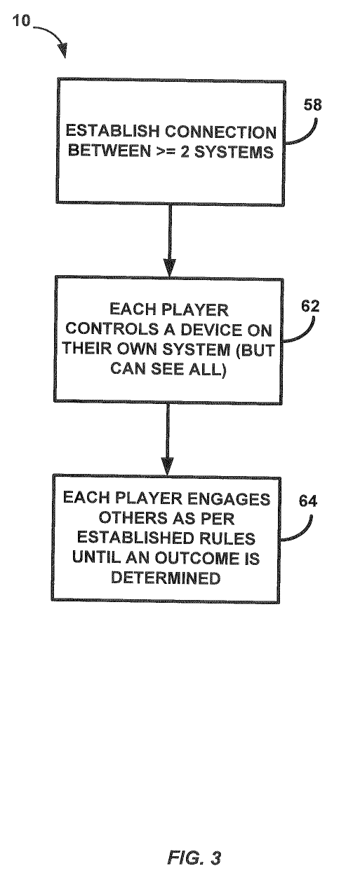

A method 10 of operating an interactive game is illustrated by the flowchart of FIG. 3. A first step 58 is to establish a connection between two or more systems. This may be by way of an internet connection, a light client, an instant messaging system, or the like. After a connection is made and selections have been made for devices and opponents, a second step 62 is that each player controls a device on their own system. They can, however, view all the devices that are currently in the game. A fourth step 64 is that each player then engages other players as per the established rules of the game until an outcome of the game is determined, at which time the game either continues or terminates. Numerous termination schemes may also be employed. For example, a user may log off, achieve a certain number of points, sustain a certain amount of damage, a timer may run out, and so on.

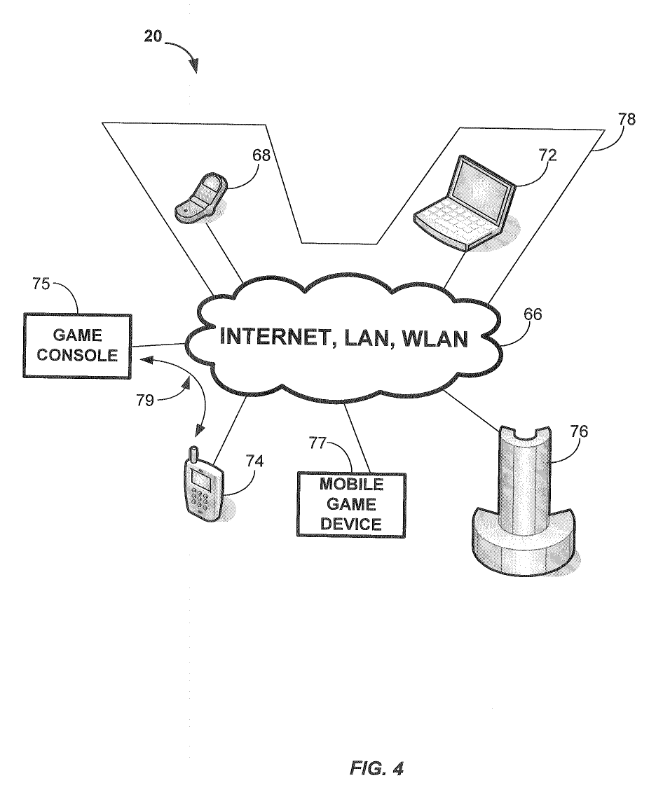

FIG. 4 shows a schematic layout of a network 20 in which the system may be implemented. A cell or mobile phone 68 is shown connected to a network 66, which may be the internet, a LAN, a WLAN, or any other such network through which information and data may be communicated. A laptop 72 is similarly connected, as is a game console 75, a smart phone 74, and a mobile game device 77. Other computer or computing systems may also be employed, including desktop computers, tablet computers, and so on. A central repository 76 may also be connected to the network, and may in some embodiments store games, device data, user profiles, or the like. The central repository 76 may also store websites through which users may play games within a website or web application, and in other implementations may act as a server for thin or light clients.

In FIG. 4, the system 20 includes a light client (indicated by element 78) installed on both cell phone 68 and laptop computer 72, and these devices may communicate through the network using this light client system. In this way, most of the functionality of the application is performed on a server, e.g., central repository 76, although in an alternative implementation, one of the computer systems may also be employed for this purpose. The light client may be constructed such that the same includes the game, initially and/or subsequently through patches or subsequent releases. The light client may be distributed to users either in packaged form or digitally-distributed.

Displaying another communication technique, the system is also shown with game console 75 and smart phone 74 communicating via an instant messaging system 79. In this way, the elements communicate by sending data back-and-forth through an instant messaging application, including mobile instant messaging. Other communication systems may also be employed.

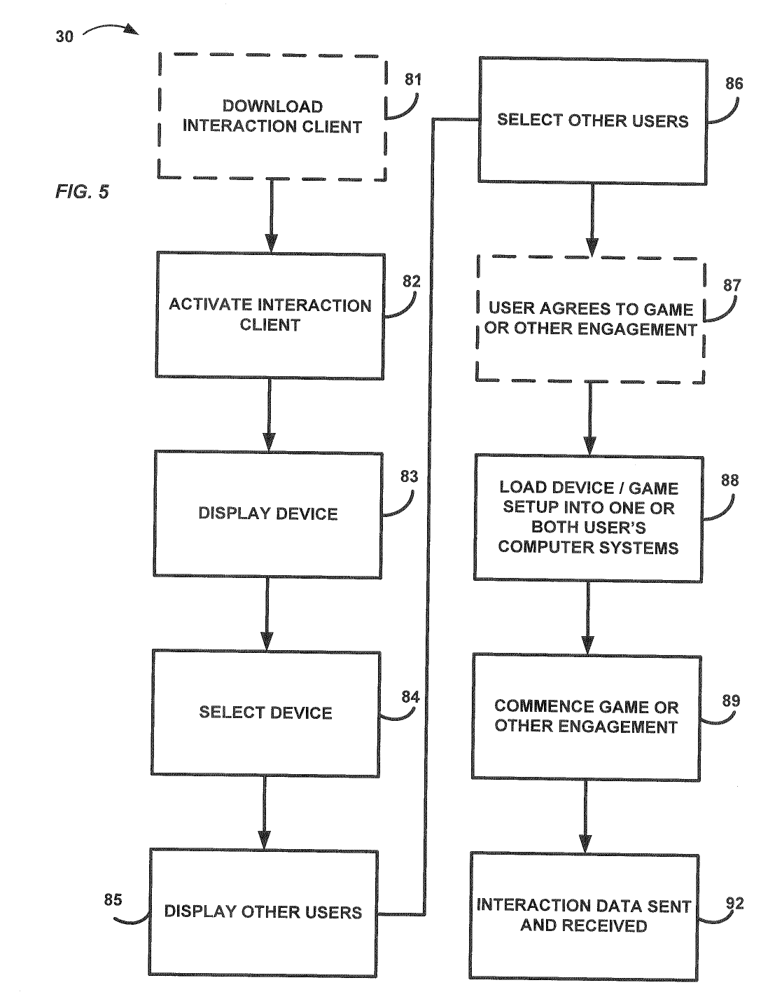

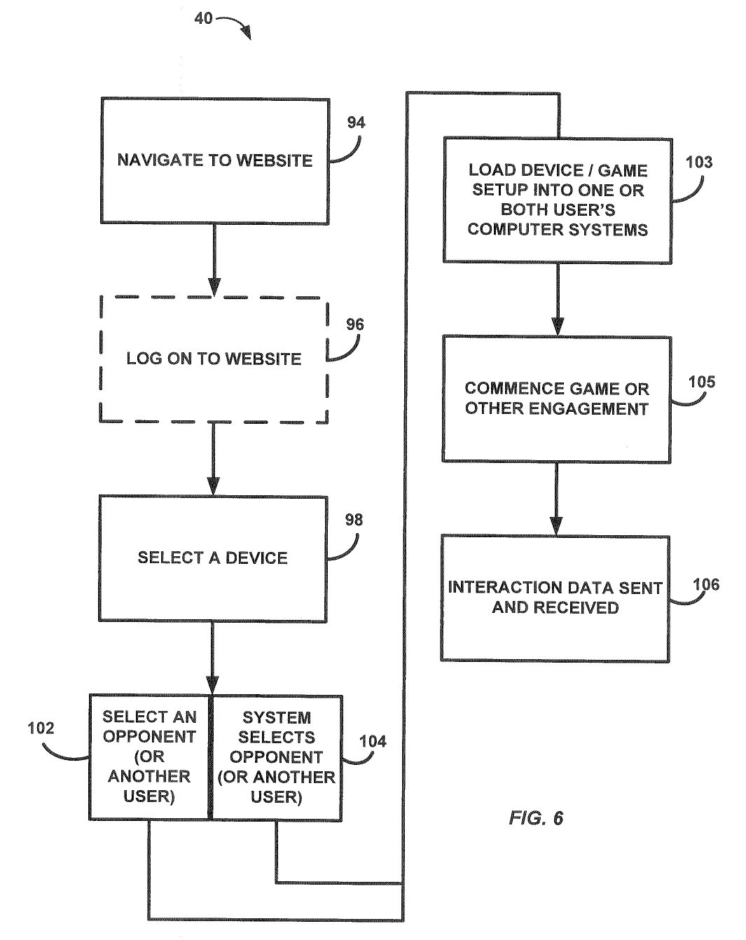

FIGS. 5 and 6 are more detailed flowcharts of the method. In FIG. 5, the method 30 is generally not web-based. On the other hand, FIG. 6 shows a web-based method 40.

Referring first to FIG. 5, a first step 81 is to download an interaction client. This may be accomplished by any number of downloading techniques, or by installing the client from a computer-readable medium. A next step 82 is to activate the interaction client, which readies the client for communication. This step may be accomplished by running the interaction client application. A next step 83 is to display one or more devices to the user using a suitable user interface, such as that described above in connection with FIG. 2. The user may then select a device (step 84). A next step 85 is the display of one or more other users, which may employ the interface of FIG. 2. The users that are displayed may be chosen on the basis of the techniques already noted, including use of a pre-defined friends or buddy list. The user then selects an opponent, i.e., another user (step 86), with which to compete or otherwise engage.

As noted above the device selection step may be combined with the user selection step by use of a drag-and-drop interface.

The selected user or users may be given the choice of whether to play the game, and the method continues if the other user so chooses (step 87). The step 87 is optional, and may be replaced by immediately depicting the device on the other user's desktop, or by numerous other ways of notifying the user that they are being requested to play a game.

To an extent necessary, the device data and game data, such as rules, may be loaded into one or both user's computer systems (step 88). For example, where device data is stored in a central repository, or where a device or game has an update that is downloadable, the same may be automatically loaded into the computer systems when the game commences. The computer system that initiated the game may generally have the device data already loaded as part of its light client. The opponent may receive the device data, if not already installed, from a central repository or from the initiating computer system in a peer-to-peer fashion. The game (or other such engagement) may then commence (step 89), and during operation of the same, interaction data is generally sent and received (step 92).

In a further implementation, illustrated in FIG. 6, the program may be embedded in a web page. In this case, the program may include a lobby system or other such player-matching system. The program may also include a pre-defined list, e.g., a web-based buddy or friends list.

Referring to FIG. 6, the method 40 begins by a user navigating to the website where the program is located (step 94). The player then logs on to the website (step 96). This step is optional as the website may require no login, or the user may have previously logged on to the system, and the system may remember the user by use of, e.g., a cookie type device. The user may then select a device (step 98). The user may further select an opponent (step 102) or the website may select one for the user (step 104), using a lobby system, e.g., a ladder system, a random-matching system, a ranked matching system, or any other system whereby users may be matched with other users. For example, the website may, with suitable permissions obtained, retrieve a friends list pertaining to the user from a social networking site to which the user belongs. Alternatively, the user may maintain a separate friends list on the gaming website. Other variations will be apparent given this teaching. As with the method of FIG. 5, the device data and game data may be (if necessary) loaded into one or both user's computer systems (step 103). The game (or other such engagement) may then commence (step 105), and during operation of the same, interaction data is generally sent and received (step 106).

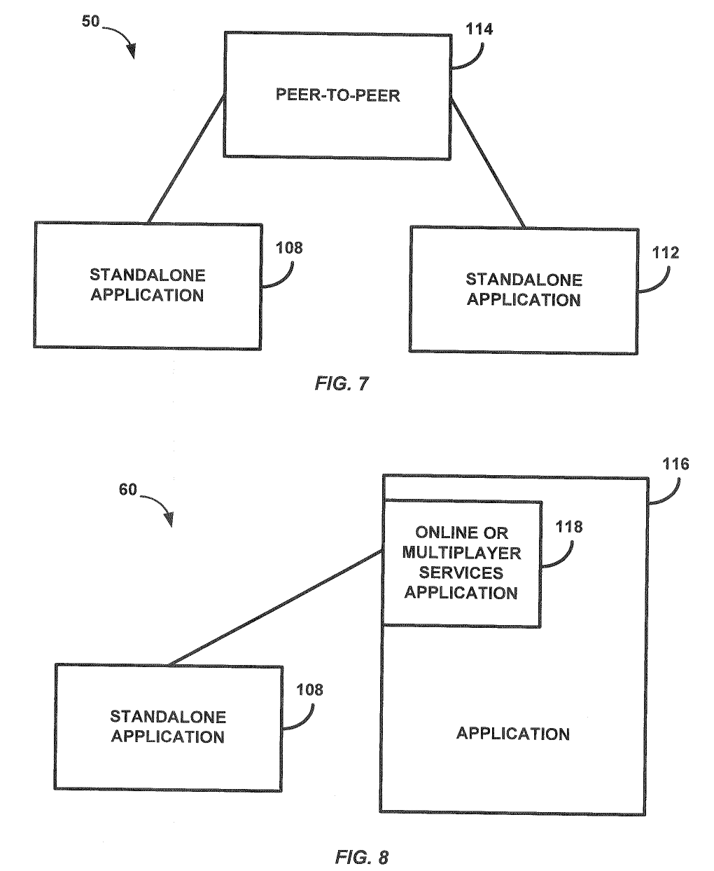

In another implementation, and referring in particular to FIG. 7, the system 50 may be configured as a stand-alone application 108. The stand-alone application 108 may communicate with, e.g, another stand-alone application 112 on an opponent system. The application 112 may be replaced in this configuration with any of the prior-mentioned configurations. In FIG. 7, applications 108 and 112 communicate via a peer-to-peer network 114, although the applications may also communicate using any of the communications techniques described.

FIG. 8 shows a system 60 in which one player is using an independent or stand-alone application 108. The stand-alone application 108 interacts with an online, multiuser, or multiplayer services application 118, which may be part of a larger application 116. This configuration may be particularly useful when one user, not affiliated with a multiplayer environment, is competing with another user who is affiliated. The not-affiliated user may log in to the online or multiplayer services component and employ the user list of the multiplayer services component to invite a user within the multiplayer community to play a game. Conversely, a multiplayer community user may employ the online interactive component of the multiplayer system to interactively transmit and receive messages (and thereby compete) with a user outside the system. Alternatively, not shown in FIG. 8, the multiplayer community user may engage in a battle of the type described with another multiplayer community user, such that the devices and device activity appear above a multiplayer community screen. For example, if the multiplayer community is a MMOG community, the devices and device activity may appear above an MMOG game screen. In this case, it may be appropriate to have devices be akin to or to correspond to those in the game; however, such a limitation is by no means necessary.

FIG. 9 depicts another feature that may be displayed on the user interface, either before or during play. In the figure, a screen 122 is shown, depicting keyboard commands and their resulting actions. Commands are shown for both players. In general, user 1 may see commands 124 appropriate for user 1; user 2 may see commands 126 appropriate for user 2; or both users may see both sets of commands (as shown). The depiction in FIG. 9 may even be employed when two players are playing on the same computing system, as the keyboard mapping is such that the two players are not using the same keys. In general, players may each employ the same keyboard mapping, and the mapping may be individually modifiable by an appropriate user interface (not shown).

Commands 124 and 126 may, e.g., display the use of a standard “asdw” or arrow keys for movement of a device, and one or more other keys for firing. A separate keyboard command 125 and 127 may be provided for upgrading a device. In particular, in some embodiments, players may purchase additional weapons and vehicles to add to their arsenal, e.g., using real currency, game currency, accumulated points, and so on. In so doing, they can better equip themselves for future games, increasing the overall enjoyment of the game. Use of keys 125 or 127 may act to display an upgrade screen which a user may use to upgrade their device, or a default upgrade may be automatically applied, with known payment information. Alternatively, the system may prompt the player for this information.

FIG. 10 illustrates a schematic modular diagram of a system 70 for user interactivity. The system 70 generally has many components. One such component is an interactive component 128. The interactive component 128 includes a transmission module 132, a device database module 134, a friends database module 136, and a user interface module 138.

The transmissions module 132 handles functions such as transmitting and receiving messages and data pertaining to device movement and activity. The device database module 132 is responsible for storing information and data about devices. The same may also store device data that is later transmitted to an opponent (or even to the initiating user) in some implementations. The friends database module 136 stores information about groups associated with the user. The same may also be employed in conjunction with the transmission module 132 (and, if necessary, an authentication module to query and receive friends or buddy list information from third-party sites, e.g., social networking sites). The user interface module 138 handles display of features, menus, data, and the like, as well as inputs and outputs.

While shown as one unit in FIG. 10, the modules may be spread over several computer systems, depending on the configuration. In a stand-alone configuration, e.g., as shown in FIG. 7, the stand-alone application, as a fat client, may include most or all of the modules. On the other hand, for a thin client, e.g., client 78 of FIG. 4, most of the modules will be on a server and separate from the user's computer system, which may only store certain device data and code for minor user interface functionality. In a web application, some device data and code for minor user interface functionality may again be temporally downloaded, but little or none is generally stored on the computer system of the user. Variations may range anywhere in-between these variations.

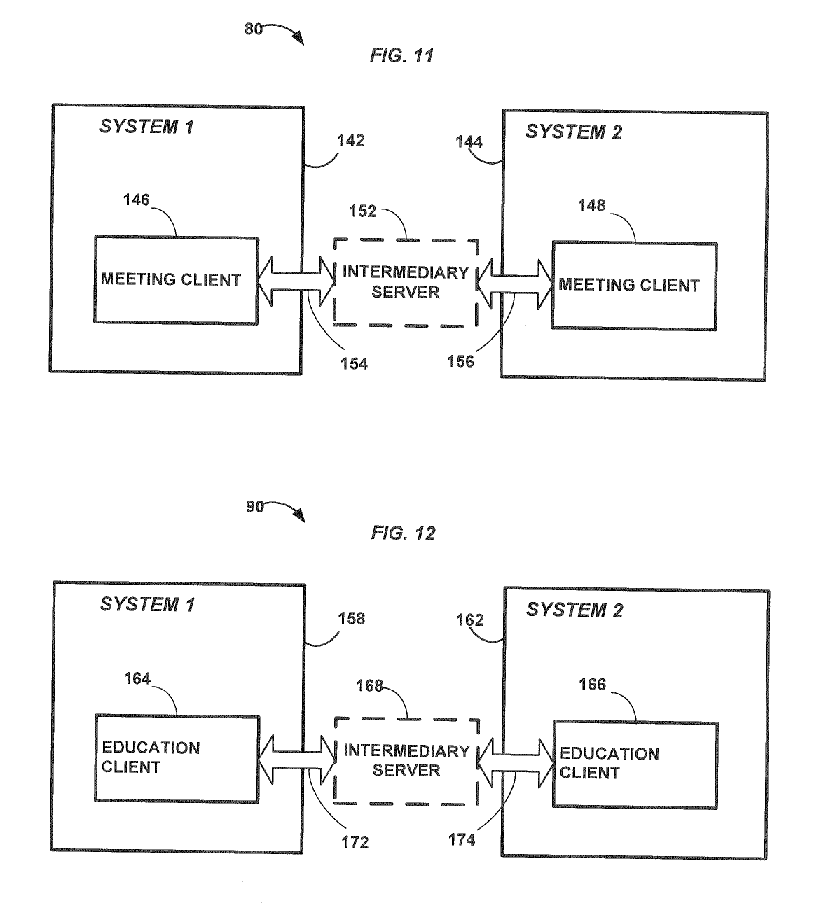

FIGS. 11 and 12 depict alternative content applications. Rather than a game, a system 80 of FIG. 11 shows system 142 (corresponding to user 1) and system 144 (corresponding to user 2) having an online meeting. A meeting client 146 of user 142 is shown communicating with a meeting client 148 of user 144 through an optional intermediary server 152. The meeting client 146 communicates with the intermediary server 152 through a communication link 154, and the meeting client 148 communicates with the intermediary server 152 through a communication link 156.

The system 80 enhances the communications of the online meeting by allowing objects to be moved around on both users' desktops in such a way that both users can see the movement and activity. These objects may be, e.g., business units in a organizational diagram, folders, icons representing personnel, account icons, or any other object with a graphical depiction and a potential reason to be graphically manipulated. In this way, both users are made aware of and can discuss object movements and ensuing ramifications. This awareness allows cursor gestures and movements, and object movements and actions, to be meaningfully transmitted, eliminating confusion and contributing to the overall effectiveness of the online meeting.

A system 90 of FIG. 12 shows system 158 (corresponding to user 1) and user 162 (corresponding to user 2) conducting an online meeting for educational purposes, e.g., user 1 may be a teacher and user 2 a student. In a way similar to the configuration of FIG. 11, an education client 164 of system 158 is shown communicating with an education client 166 of system 162 through an optional intermediary server 168. The education client 164 communicates with the intermediary server 168 through a communication link 172, and the education client 166 communicates with the intermediary server 168 through a communication link 174.

The system 90 may be useful and beneficial in educational environments as both users may view the movement of objects (by one or both users) on both users' desktops. These objects may be, e.g., words in a term paper, symbols in an equation, or any other educational object with a graphical depiction and a potential reason to be graphically manipulated. In this way, a student can view how a teacher is solving a problem, rewriting a paper, and the like.

The systems of FIGS. 11 and 12 may be generally accompanied by voice conferencing systems. In addition, both systems may benefit by allowing mouse or tablet control of the “devices”, rather than just device control via arrow keys or the like. In this way, teachers and students may point, using a cursor, at a chosen item, and drag it to a desired location, pull it off the screen, or perform any other action as desired.

According to embodiments of the present invention, as fully described above, systems and methods are provided for allowing interactivity between computer systems, especially for casual and short-term games.

One implementation includes one or more programmable processors and corresponding computer system components to store and execute computer instructions, such as to provide the light client or stand-alone application.

Additional variations and implementations are also possible. For example, the modules described may be spread over two or more networked systems or servers, rather than only within one computer system. The system and method may be embodied in a software application that may be distributed to end-users. The user may interact with one or more computer-controlled “users” in addition to, or instead of, human users.

In other implementations, one or more of the users in an interactive session may use different devices than a desktop computer system, such as a game console, a cellular phone, a mobile game device, a personal digital assistant, and so on. In general, while the term “computer” has been used, this term is intended to encompass any computing machine, including desktop computers, laptop computers, handheld computers, tablet computers, smart phones, personal digital assistants, cell phones, mobile phones, satellite phones and any other device to or from which data may be transferred. Various other examples could also be formulated given this teaching.

While the invention has been described with respect to certain embodiments, it should be clear to one of ordinary skill in the art, given this teaching, that the invention is much broader than the embodiments shown. Accordingly, the description represents some, but not all, representations, and therefore the scope of this invention is to be limited only by the claims appended to this description.

What is claimed is:

1. A method of interacting over a computer network, comprising:
a. activating an interaction client on a first computer system;
b. displaying one or more devices by a user interface associated with the interaction client, wherein the interaction client stores device data for each device;
c. receiving a selection of one or more devices displayed by the user interface;
d. displaying a list of one or more names by the user interface, the names corresponding to respective users and computer systems;
e. receiving a selection of one or more of the displayed names;
f. transmitting the device data for the selected device to the computer system or systems corresponding to the selected name or names; and
g. transmitting and receiving interaction data to and from the computer system or systems corresponding to the selected name or names, wherein the interaction data indicate commands input by users for their devices.

2. The method of claim 1, wherein the interaction client is a game, and wherein the devices are objects within the game.

3. The method of claim 1, wherein the computer systems are selected from the group consisting of: mobile devices, personal computers, personal digital assistants, smart phones, mobile phones, cell phones, satellite phones, tablet computers, handheld computers, desktop computers, and laptop computers.

4. The method of claim 1, further comprising displaying the device corresponding to the device data on the first computer system and displaying one or more respective devices on the computer system or systems corresponding to the selected name or names.

5. The method of claim 4, wherein the devices are displayed on a personal computer desktop or background.

6. The method of claim 1, wherein the user interface employs drag-and-drop functionality.

7. The method of claim 1, wherein the transmitting and receiving are performed by a light client or by an instant messaging system.

8. The method of claim 5, further comprising modifying the appearance of a graphical element on the computer desktop or background in response to the transmitting and receiving interaction data.

9. The method of claim 1, wherein the interaction client is an educational or meeting tool.

10. The method of claim 2, wherein the devices may be modified by the players, and further comprising receiving a request from the interaction client to modify their associated device.

11. The method of claim 10, further comprising receiving compensation from a player through the interaction client as consideration for the requested modification.

12. A method of operating an online video game in which a game client application has been downloaded to a first computer system and to a second computer system, the client applications enabling a game to be played between the first and second computer systems, comprising:
a. providing a user interface including a first device corresponding to the first computer system and a second device corresponding to the second computer system;
b. receiving input commands from the first and second computer systems, input commands from the first computer system corresponding to commands to move or operate the first device, and input commands from the second computer system corresponding to commands to move or operate the second device;
c. transmitting data, corresponding to the received input commands of one computer system, to the other computer system; and
d. receiving the transmitted data and updating the movement or operation of each device on each computer system according to the received input commands and received data,
e. such that the transmitting is performed using:
i. an instant messaging system;
ii. a light client; or
iii. a lobby system in a web application, the web application in communication with each of the first and second computer systems.

13. The method of claim 12, wherein the receiving input commands corresponds to receiving commands to move the device in one of at least four possible directions, and wherein the receiving input commands further corresponds to receiving commands to fire a projectile.

14. The method of claim 12, wherein the first or second devices are displayed on a personal computer desktop or mobile phone background.

15. The method of claim 14, further comprising modifying the appearance of a graphical element on the computer desktop or background in response to the received data.

16. A system for use by a first user to interact over a computer network with one or more other users, comprising:
a. a device database module to store information corresponding to one or more devices, the devices being graphical elements;
b. a friends database module to store information corresponding to one or more users associated with a first user;
c. a user interface module through which the first user may choose at least one device and at least one user with which and with whom to interact, respectively; and
d. a transmission module to send and receive interaction data.

17. The system of claim 16, wherein the interaction data include information about movement and actions of the devices.

18. The system of claim 16, wherein the devices correspond to elements in a game and wherein the interaction data correspond to movements or actions of the devices within the game.

19. The system of claim 16, wherein the device database module, friends database module, user interface module, and transmission module, are located on a computer system, and wherein the computer system is selected from the group consisting of: mobile devices, personal computers, personal digital assistants, smart phones, mobile phones, cell phones, satellite phones, tablet computers, handheld computers, desktop computers, and laptop computers.

20. The system of claim 16, wherein the transmission module sends and receives data using:
a. an instant messaging system;
b. a light client; or
c. a lobby system in a web application, the web application in communication with each of the first and second computer systems.
